(19) United States
(12) Patent Application Publication
(10) Pub. No.: US 2013/0184941 A1
(43) Pub. Date: Jul. 18, 2013

(54) METHOD AND DEVICE FOR PROTECTING A VEHICLE OCCUPANT IN THE EVENT OF AN IMPACT

(71) Applicants: Heiko Freienstein, Weil Der Stadt (DE); Jens Schrader, Baden-Baden (DE)

(72) Inventors: Heiko Freienstein, Weil Der Stadt (DE); Jens Schrader, Baden-Baden (DE)

(21) Appl. No.: 13/809,131

(22) PCT Filed: May 16, 2011
(86) PCT No.: PCT/EP2011/057836

§ 371 Date: Mar. 26, 2013

(30) Foreign Application Priority Data
Jul. 12, 2010 (DE) 102010031261.4

(51) Int. Cl. B60R 21/0134

(52) U.S. Cl. CPC B60R 21/0134
USPC 701/45

(57) ABSTRACT

A method and a device for protecting a vehicle occupant. In the event of an impact in which the vehicle occupant is moved in an impact direction prior to the impact. During a first phase, the vehicle occupant is stabilized by a first actuator as a function of a pre-crash signal. During a second phase, which follows the first phase, the vehicle occupant is moved by a second actuator in the impact direction as a function of a signal characterizing a starting or an inevitable crash.

### FIELD

The present invention relates to a method and a device for protecting a vehicle occupant in the event of an impact.

### BACKGROUND INFORMATION

Baumann et al.: PRE-SAFE PULSE, the expansion of the occupant protection by using the pre-accident phase, VDA's Technical Congress 2010, describes moving the occupant to be protected, even before the actual impact, with the aid of a pre-impetus or pre-impulse in the direction in which the occupant will be pushed anyway via the restraint system during the main impetus. This is supposed to mitigate the injury consequences for the vehicle occupant.

### SUMMARY

An example method according to the present invention and an example device according to the present invention for protecting a vehicle occupant in the event of an impact may have the advantage that the vehicle occupant is now stabilized during a first phase, which is an early pre-crash phase, for example. During a second phase, the vehicle occupant is moved by a pre-impulse, by another actuator, namely in the direction in which the restraint system in the impact pushes anyway, that is, the impact direction. During the crash phase, which follows this second phase, the vehicle occupant bumps at a reduced impact speed against the first actuator. In this way, the posture of the vehicle occupant may be optimally provided by the first actuator during the first phase for the impulse in the second phase. Moreover, the second actuator is applied directly to the occupant. This means that no additional distance must be covered, which would cause disadvantages with regard to the design of the second actuator. This second actuator may, as is apparent from the dependent claims, be irreversible since this second actuator is ignited only after a crash inevitability. Overall, the example device according to the present invention and the example method according to the present invention allow for a higher tolerance against erroneous triggering events.

The crash phase, which follows the second phase, is characterized by the crash or the impact per se, i.e., the impact proceeds.

The present invention is suited in particular for side impact protection, since the actuator has a particularly important protective function here.

In the present case, an impact or also a crash is a collision with an object, the consequences of which are dangerous for the vehicle occupants.

The direction in which the vehicle occupant is moved by the second actuator is the impact direction. This means that if the impact comes from the left, seen from the longitudinal direction of the vehicle, the impact direction is to the right, and the vehicle occupant is thus also moved to the right by this impulse. During the impact itself, inertia must be observed, i.e., the vehicle occupant will initially move toward the side the impact object acts on. The object of the method according to the present invention and of the device according to the present invention is to reduce the severity of this impact of the vehicle occupant against the impact plate provided there or against the first actuator. This is achieved by the impulse to initially move the vehicle occupant in the opposite direction.

“Move” usually means a forceful push, which is carried out by the second actuator and is caused by an airbag or a pressure-relieving spring element, for example.

The first phase is understood as an early pre-crash phase during which a surroundings sensor system detects a high impact probability, in particular side impact probability, using radar, video, ultrasound, etc. In this case, this probability may be above 50%, for example. The second phase, which directly follows this early pre-crash phase, may be referred to as a late pre-crash phase. The vehicle occupant is stabilized during the first phase by the first actuator. Now, during the second phase, the occupant receives the impulse or the pre-acceleration if the signal indicates an inevitable or already starting crash. An inevitable impact may be detected by analyzing a pre-crash signal, while the starting crash is detectable with the aid of an impact sensor device such as an acceleration sensor system.

The two interfaces may be implemented as hard- and/or software. The sensor system, in particular the pre-crash sensor system, is situated in the front of the vehicle or in other suitable places in the vehicle. If an impact sensor system is used for generating the signal, it may be situated in an airbag control unit or outside.

The pre-crash signal and the signal may be previously obtained data or already analyzed data.

The control unit, e.g., a microcontroller, is located in an airbag control unit which activates the first and/or the second actuator(s) as a function of the analysis of the pre-crash signal and the other signal.

Another advantageous embodiment is a system having the device, which is ultimately only the electronic system, in combination with the first and the second actuators.

It may be particularly advantageous if the first actuator is a side bolster and the second actuator is an airbag, a firing channel for letting the expanding gas out of a gas generator and into the airbag being provided in the side bolster. This makes it clear that the first actuator may refer to a side bolster, and the second actuator may refer to at least a spring element. As previously mentioned, a pyrotechnical design is also possible.

It may be also advantageous if the first actuator is operated reversibly. This means that in the event of an erroneous triggering event, the starting position of the first actuator may be easily resumed. An example of such a reversibly designed actuator is an electric motor-driven pneumatically hydraulically designed actuator. In contrast, the second actuator may be designed generally irreversibly, i.e., as a pyrotechnically operated actuator.

The vehicle occupant may be stabilized essentially by providing lateral support. This lateral support may extend in the area of the thighs, the pelvis and up until the lower thoracic region.

The stabilization continues during the first phase, the second phase, and beyond. The stabilization may be, on the one hand, important for the impulse to be applied optimally by the second actuator to the vehicle occupant in such a way that the protection of the vehicle occupant is optimized.

On the other hand, it may be advantageous if the second actuator is operated faster than the first actuator. This is possible in a simple manner in particular by designing the second actuator as a pyrotechnically operated actuator.

### BRIEF DESCRIPTION OF THE DRAWINGS

Exemplary embodiments are depicted in the figures and explained in greater detail below.

FIG. 1 shows a block diagram of the entire system.

FIGS. 2 through 4 show three phases of the vehicle occupant in the event of a side impact.

FIG. 5 shows a first exemplary embodiment for the first and the second actuators.

FIG. 6 shows a second exemplary embodiment.

FIG. 7 shows a third exemplary embodiment.

FIG. 8 shows a fourth exemplary embodiment.

FIG. 9 shows a flow chart of an example method according to the present invention.

### DETAILED DESCRIPTION OF EXAMPLE EMBODIMENTS

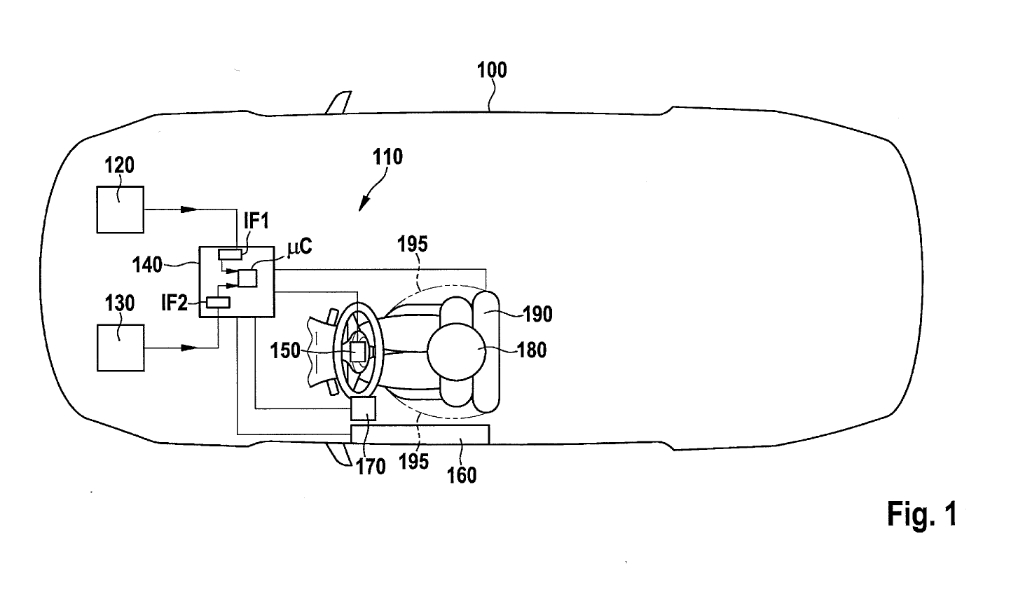

FIG. 1 shows in a block diagram device 140 according to the present invention as well as system 110 according to the present invention in vehicle 100. Signals from acceleration sensors 120 and pre-crash sensor system 130 are input into control unit 140. They are input via interfaces IF1 and IF2. The interfaces are connected to microcontroller μC as the control unit so that microcontroller μC may generate the control signals for the actuators, namely the side bolsters, and the side airbags, and the front airbags. The front airbags have reference numeral 150, the side airbags have reference numeral 160, the side bolsters have reference numeral 195, and the headrest has reference numeral 190 for vehicle occupant 180. Reference numeral 170 identifies the airbags. The method according to the present invention runs on microcontroller μC. This means that during the first phase, namely the early pre-crash phase, the stabilization of vehicle occupant 180 is achieved by side bolsters 195.

During the second phase, namely the late pre-crash phase, an impulse in the impact direction acts upon vehicle occupant 180 in the event of an already starting or inevitable crash. During the actual in-crash phase, the vehicle occupant performs a so-called rebound and moves in the other direction, namely toward the impact location. Due to the pre-acceleration, a reduced impact energy occurs, which is a quadratic function of the impact speed, which is now reduced. The first actuator continues to remain in its position which it assumed during the first phase, and thus restrains the vehicle occupant.

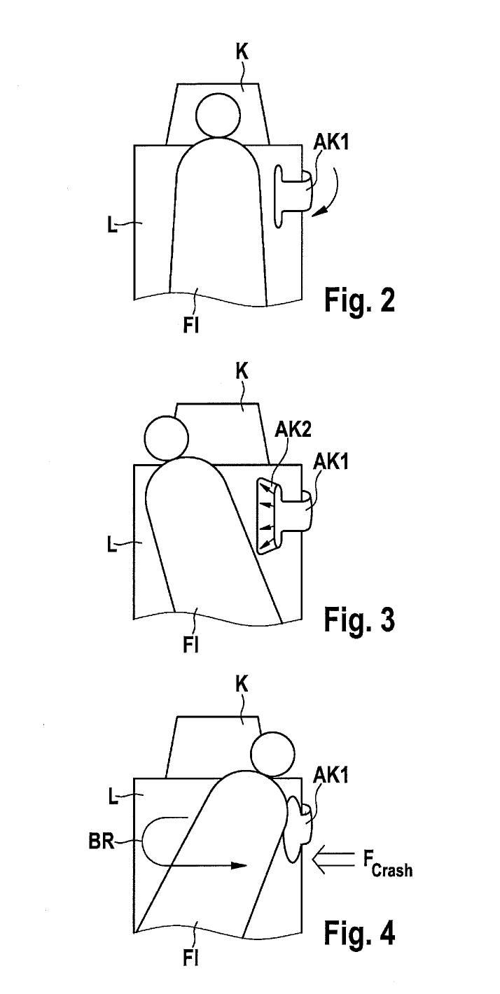

FIGS. 2 and 4 describe the individual phases prior to a side impact of the vehicle occupant. A schematic representation has been selected. FIG. 2 describes the early pre-crash phase. Vehicle occupant FI, who sits in a vehicle seat having armrest

L and head rest K, is stabilized by first actuator AK1 which is electric motor-driven, for example.

FIG. 3 shows that, during the late pre-crash phase, second actuator AK2 has applied a push to vehicle occupant FI via an airbag. Consequently, vehicle occupant FI moves away from the possible impact location.

FIG. 4 now shows the in-crash case during which no further action of the device according to the present invention is carried out. Vehicle occupant FI bumps against the impact plate. The direction of the crash is indicated by the direction of the arrow.

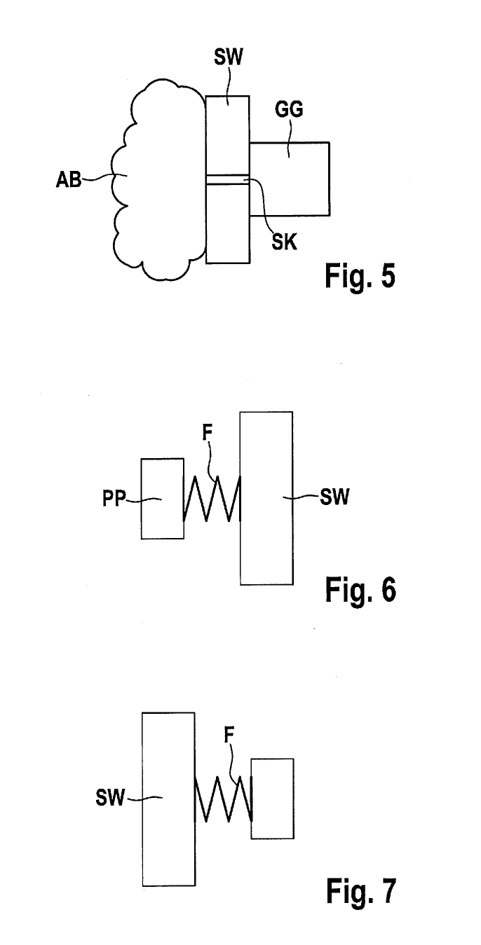

FIG. 5 shows a first specific embodiment of the first and the second actuators. An airbag AB is inflated by a gas generator GG via a firing channel SK through a side bolster SW, when activated.

In FIG. 6, a spring is loaded between an impact plate PP and side bolsters SW. According to FIG. 7, the side bolster as the first actuator due to spring element F is used to apply an impulse to the vehicle occupant.

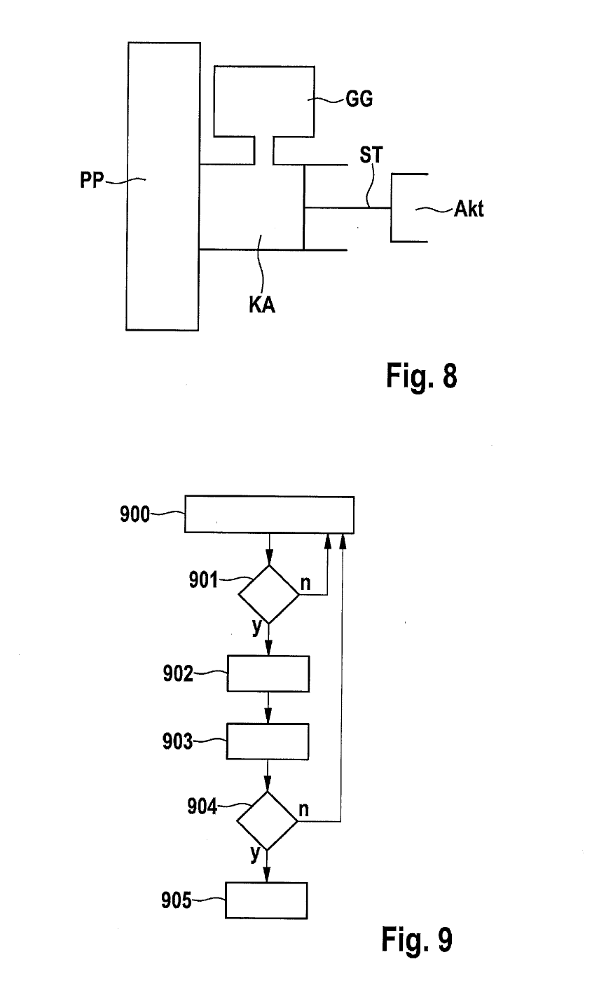

FIG. 8 shows another specific embodiment of the device according to the present invention. The impact plate is adjoined by a chamber KA having a stamp ST which is activated by an actuator AKT. Chamber KA is connected via a channel to a gas generator GG.

FIG. 9 shows a flow chart of the method according to the present invention. In method step 900, a pre-crash signal is analyzed by microcontroller μC and, in method step 901, it is subjected to a comparison value as to whether or not there is a risk of an impending impact. If this is not the case, a jump is made to method step 900. If, however, this is the case, a stabilization takes place in method step 902 during the first phase and, in method step 903, a control signal is generated in the control unit, it being determined in method step 904 whether the second stage has in fact ignited. This is stored in method step 904. In method step 905, the impulse is applied to the vehicle applicant.

The disclosure of the German Patent Application No. DE 102009001426.8 is expressly integrated herein by reference in its entirety.

1-10. (canceled)

11. A method for protecting a vehicle occupant in the event of an impact, comprising:
stabilizing, during a first phase, the vehicle occupant by a first actuator as a function of a pre-crash signal; and
moving, during a second phase which follows the first phase, the vehicle occupant by a second actuator in an impact direction as a function of a signal characterizing a starting impact or an inevitable impact.

12. The method as recited in claim 11, wherein the first actuator is operated reversibly.

13. The method as recited in claim 11, wherein the second actuator is operated irreversibly.

14. The method as recited in claim 11, wherein the vehicle occupant is stabilized by providing a lateral support.

15. The method as recited in claim 11, wherein the stabilization continues during the first and the second phases and beyond.

16. The method as recited in claim 11, wherein the second actuator is operated faster than the first actuator.

17. A device for protecting a vehicle occupant, comprising:
a first interface configured to provide a pre-crash signal;
a second interface configured to provide a signal characterizing an inevitable impact or starting impact; and
a control unit configured to activate as a function of a pre-crash signal a first actuator to stabilize the vehicle occupant during a first phase, and activate as a function of a signal a second actuator to move the vehicle occupant in an impact direction during a second phase, which follows the first phase.

18. A system for protecting a vehicle occupant in the event of an impact, the system comprising:
a first actuator;
a second actuator;
a first interface configured to provide a pre-crash signal;
a second interface configured to provide a signal characterizing an inevitable impact or starting impact; and
a control unit configured to activate as a function of a pre-crash signal a first actuator to stabilize the vehicle occupant during a first phase, and activate as a function of a signal a second actuator to move the vehicle occupant in an impact direction during a second phase, which follows the first phase.

19. The system as recited in claim 18, wherein the first actuator is a side bolster, and the second actuator is an airbag, a firing channel being provided in the side bolster.

20. The system as recited in claim 18, wherein the first actuator is a side bolster, and the second actuator is at least one spring element.
